(19) United States
(12) Patent Application Publication
(10) Pub. No.: US 2021/0405442 A1
(43) Pub. Date: Dec. 30, 2021

(54) DISPLAY PANEL, MANUFACTURING METHOD OF DISPLAY PANEL, AND DISPLAY DEVICE

(71) Applicant: TCL China Star OPtoelectronics Technology Co., Ltd., Shenzhen (CN)

(72) Inventor: Baolin CHI, Shenzhen (CN)

(73) Assignee: TCL China Star OPtoelectronics Technology Co., Ltd., Shenzhen (CN)

(21) Appl. No.: 16/652,426

(22) PCT Filed: Feb. 28, 2020
(86) PCT No.: PCT/CN2020/077225

§ 371 Date: Mar. 31, 2020

(30) Foreign Application Priority Data
Jan. 15, 2020 (CN) 202010039833.4

(51) Int. Cl. G02F 1/1335

(52) U.S. Cl. CPC G02F 1/133512

(57) ABSTRACT

The present disclosure provides a display panel, a manufacturing method of the display panel, and a display device. The display panel includes a substrate, a black matrix, and a polymer film disposed between the substrate and the black matrix and used to increase an adhesive force between the substrate and the black matrix. The polymer film as an adhesive can enhance the adhesive force between the black matrix and the substrate to prevent the black matrix from peeling off from the substrate.

### CROSS REFERENCE TO RELATED APPLICATIONS

The present application claims priority of the Chinese patent application No. 202010039833.4 filed on Jan. 15, 2020 with the National Intellectual Property Administration, titled “Display panel, manufacturing method of display panel, and display device”, which is incorporated by reference in the present application in its entirety.

### FIELD OF INVENTION

The present disclosure relates to the field of display panel manufacturing technologies, and more particularly, to a display panel, a manufacturing method of the display panel, and a display device.

### BACKGROUND OF INVENTION

Liquid crystal displays (LCDs) have developed rapidly and have been widely welcomed due to their thin profiles, low power consumption, and low production cost. Current LCDs have mature production technology, high product yield, and high market acceptance, and are widely applied to devices of vehicles, computers, televisions, and more.

Outdoor display panels are gradually being valued amid fierce competition of current liquid crystal display industry. A most important characteristic of outdoor displays is their ability to withstand harsh outdoor environment, such as high temperature and high humidity environment. Wherein, an adhesive force to a substrate is an important test item.

In current mainstream processing conditions, a black matrix (BM) will directly contact a substrate. Under normal circumstances, when considering adhesive force of a panel, adhesive force between frame glue and indium tin oxide (ITO) layers on both sides and adhesive force between a substrate and materials (a metal and a black matrix) on both sides are mainly taken into account. It can be known from conventional tests that interfaces which are easy to peel off are mainly between frame glue and ITO and between a black matrix and a glass substrate, and the majority of panel peeling occurs between the black matrix and the glass substrate. The adhesive force between the black matrix and the glass substrate mainly relies on intermolecular forces, and black matrix materials have no adhesive forces. Under a high temperature and high humidity environment, due to environmental changes, intermolecular forces between the black matrix and the glass substrate will decrease, thereby decreasing the adhesive force between the black matrix and the glass substrate and causing them to peel off. Peeling off of substrates often brings a greater loss to products.

Technical problem: an embodiment of the present disclosure provides a display panel, a manufacturing method of the display panel, and a display device to prevent a substrate from peeling off from a black matrix.

### SUMMARY OF INVENTION

The present disclosure provides a display panel which includes a substrate, a black matrix on the substrate, and a polymer film disposed between the substrate and the black matrix and used to increase an adhesive force between the substrate and the black matrix. The polymer film is as an adhesive, so it can enhance the adhesive force between the black matrix and the substrate to prevent the black matrix from stripping off from the substrate.

In some embodiments, the polymer film comprises at least one acrylate polymer unit, and an adhesive force of the acrylate polymer is greater than 35N/25*25 mm*50 nm (thickness). Wherein, “N” represents Newton, “nm” represents nanometer, and “mm” represents millimeter.

In some embodiments, the acrylate polymer is manufactured according to a first monomer and a second monomer, and the first monomer and the second monomer are acrylate derivatives.

In some embodiments, the first monomer is dimethylaminoethyl methacrylate.

In some embodiments, the second monomer is 2-chloroethyl acrylate.

In some embodiments, the polymer film is manufactured by chemical vapor deposition and a thermal curing process according to the first monomer and the second monomer.

an embodiment of the present disclosure further provides a manufacturing method of a display panel. The method comprises:

using a first monomer and a second monomer to form a layer of an intermediate product of a polymer film on a substrate;

coating a black matrix on the intermediate product of the polymer film; and

making the intermediate product of the polymer undergo a thermal cross-linking reaction to form the polymer film having a certain adhesive force.

In some embodiments, the first monomer is dimethylaminoethyl methacrylate.

In some embodiments, the second monomer is 2-chloroethyl acrylate.

In some embodiments, the intermediate product of the polymer film is manufactured by chemical vapor deposition according to a first monomer and a second monomer.

In some embodiments, the polymer film is manufactured by undergoing a thermal cross-linking reaction in a thermal curing process according to an intermediate product of the polymer film.

In some embodiments, a thickness of the polymer film is less than 500 nm.

In some embodiments, in the manufacturing method of the display panel, a thermal curing reaction temperature ranges from 100° C. to 140° C.

The present disclosure further provides a display device which comprises a display panel. The display panel comprises a substrate, a black matrix, and a polymer film disposed between the substrate and the black matrix and used to increase an adhesive force between the substrate and the black matrix.

In some embodiments, the polymer film comprises at least one acrylate polymer unit, the acrylate polymer is manufactured according to a first monomer and a second monomer, and the first monomer and the second monomer are acrylate derivatives.

In some embodiments, a transmittance of the acrylate polymer ranges from 99% to 100%.

In some embodiments, the first monomer is dimethylaminoethyl methacrylate.

In some embodiments, the second monomer is 2-chloroethyl acrylate.

In some embodiments, a thickness of the polymer film is less than 500 nm.

In some embodiments, the polymer film is manufactured by undergoing a thermal cross-linking reaction in a thermal curing process according to an intermediate product of the polymer film.

Beneficial effect: the display panel provided by the present disclosure has a polymer film disposed between a substrate and a black matrix, and the polymer film has an adhesive force, which can allow the black matrix to better attach to the substrate and effectively prevent the black matrix from peeling off from the substrate. Because the polymer film has stable physical and chemical properties under a high temperature and high humidity environment, it can still maintain a good adhesive force between the substrate and the black matrix. On the other hand, the polymer film layer added between the substrate and the black matrix has flexibility, so it can also be applied to the field of flexible panels. Besides, through controlling selection of materials, thicknesses, and reaction conditions, it will not bring negative influences on characteristics of the display panel, such as transmittance, conductivity, and stability.

The manufacturing method of the display panel provided by the present disclosure uses chemical vapor deposition to manufacture a thin film. The thin film is dense and uniform, and a thickness thereof is controllable. The thickness can be controlled within 500 nm. The method can allow the black matrix to be coated uniformly and can effectively control a thickness of the panel. Solvents are not required in overall manufacturing processes, the processes are controllable, and reaction conditions of the processes are mild, which will not affect characteristics of other materials in the display panel.

### DESCRIPTION OF DRAWINGS

FIG. 1 is a schematic cross-sectional diagram of a display panel according to an embodiment of the present disclosure.

FIG. 2 is a schematic cross-sectional diagram of a black matrix, a substrate, and a polymer film according to an embodiment of the present disclosure.

FIG. 3 is a flowchart of a manufacturing method of a display panel.

### DETAILED DESCRIPTION OF PREFERRED EMBODIMENTS

The embodiments of the present disclosure are described in detail hereinafter. Examples of the described embodiments are given in the accompanying drawings. The specific embodiments described with reference to the attached drawings are all exemplary and are intended to illustrate and interpret the present disclosure. Based on the embodiments in the present disclosure, all other embodiments obtained by those skilled in the art without creative efforts are within the scope of the present disclosure.

In the description of the present disclosure, it should be understood that terms such as “center”, “longitudinal”, “lateral”, “length”, “width”, “thickness”, “upper”, “lower”, “front”, “rear”, “left”, “right”, “vertical”, “horizontal”, “top”, “bottom”, “inside”, “outside”, as well as derivative thereof should be construed to refer to the orientation as described or as shown in the drawings under discussion. These relative terms are for convenience of description, do not require that the present disclosure be constructed or operated in a particular orientation, and shall not be construed as causing limitations to the present disclosure. In addition, terms such as “first” and “second” are used herein for purposes of description and are not intended to indicate or imply relative importance or implicitly indicating the number of technical features indicated. Thus, features limited by “first” and “second” are intended to indicate or imply including one or more than one these features. In the description of the present disclosure, “a plurality of” relates to two or more than two, unless otherwise specified.

It can be known from conventional tests that interfaces which are easy to peel off in a display panel are mainly between frame glue and ITO and between a black matrix and a glass substrate. Under normal conditions, an adhesive force between the black matrix and the glass substrate mainly relies on intermolecular forces, and black matrix materials have no adhesive forces. Under a high temperature and high humidity environment, environmental changes can cause intermolecular forces between the black matrix and the glass substrate to decrease, thereby decreasing the adhesive force between the black matrix and the glass substrate and causing them to peel off. An embodiment of the present disclosure adds a layer of polymer film between a substrate and a black matrix to increase an adhesive force between the substrate and the black matrix. The polymer film is an adhesive, so it can enhance the adhesive force between the black matrix and the substrate to prevent the black matrix from peeling off from the substrate.

The following is a detailed description.

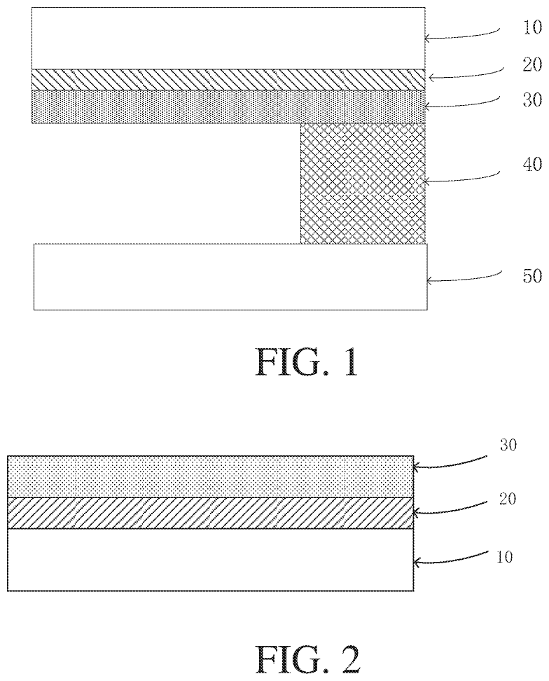

Referring to FIGS. 1 and 2, FIG. 1 is a schematic cross-sectional diagram of a display panel according to an embodiment of the present disclosure, and FIG. 2 is a schematic cross-sectional diagram of a black matrix 30, a substrate 10, and a polymer film 20 in the display panel.

First of all, an embodiment of the present disclosure provides a display panel. The display panel comprises a first substrate 50, a second substrate 10 disposed opposite to the first substrate 50, a frame glue 40 which provides an adhesive effect along edges of the first substrate 50 and the second substrate 10, and liquid crystals (not shown) between the first substrate 50 and the second substrate 10.

A black matrix 30 is disposed on the second substrate 10, and a polymer film 20 which is used to increase an adhesive force of the black matrix 30 is disposed between the second substrate 10 and the black matrix 30.

Specifically, the adhesive force refers to adhesion, which is a force that can stick two planes to each other. Preferably, the adhesive force of the polymer film in the embodiment is greater than 35N/25*25 mm*50 nm (thickness).

Specifically, a transmittance of the polymer film in the embodiment is greater than 50%. In preferred embodiments, the transmittance is at least 60%, 70%, 80%, 85%, 90%, or 95%, or any ranges between the transmittance values from the above example values.

In an embodiment of the present disclosure, the second substrate 10 is a glass substrate, and it can also be an organic flexible substrate. Specifically, the organic flexible substrate is a polyimide substrate.

In an embodiment of the present disclosure, the black matrix 30 is a light-shielding material, which can be a black resin. The black matrix 30 is used to define sub-pixel areas and can also be used to prevent the display panel from light leakage.

In an embodiment of the present disclosure, the polymer film 20 can be made of an acrylate polymer. Specifically, the acrylate polymer is a network polymer CEA-co-DEAEMA polymerized using dimethylaminoethyl methacrylate (DMAEMA) and 2-chloroethyl acrylate (CEA), and the acrylate polymer can also be formed by mixing an acrylate polymer with other materials.

In a preferred embodiment of the present disclosure, the acrylate polymer is polymerized using dimethylaminoethyl methacrylate (DMAEMA) and 2-chloroethyl acrylate (CEA) by chemical vapor deposition and a thermal curing process.

In current technology, the black matrix 30 is generally disposed on the second substrate 10. Under an external force, an intermolecular force between the black matrix 30 and the second substrate 10 is less than the external force, so the black matrix 30 is usually pulled to a side of the first substrate 50. The embodiment of the present disclosure adds a layer of thin film between the black matrix 30 and the second substrate 10. Compared to the intermolecular force, the thin film has a greater adhesive force on both sides of materials (the black matrix 30 and the second substrate 10). When the adhesive force is greater than 35N/25*25 mm*50 nm (thickness), the black matrix 30 is not easily pulled to another side under a same external force.

An embodiment of the present disclosure provides a display panel which has a polymer film 20 disposed between a substrate 10 and a black matrix 30, and the polymer film 20 has an adhesive force, which can allow the black matrix 30 to better attach to the substrate 10 and effectively prevent the black matrix 30 from peeling off from the substrate 10. Because the polymer film 20 has stable physical and chemical properties under a high temperature and high humidity environment, it can still maintain a good adhesive force between the substrate 10 and the black matrix 30. On the other hand, the polymer film layer added between the substrate 10 and the black matrix 30 has flexibility, so it can also be applied to the field of flexible panels. Besides, through controlling selection of materials, thicknesses, and reaction conditions, it will not bring negative influences on characteristics of the display panel, such as transmittance, conductivity, and stability.

It should be noted that only above structures are described in the above embodiments of the display panel, but it can be understood that in addition to the above structures, the display panel in the embodiment of the present disclosure can also comprise other necessary structures according to requirements, such as thin film transistors (TFTs), color filters, ITO, etc., which are not specifically limited herein.

In order to better implement the display panel in the embodiments of the present disclosure, based on the display panel, an embodiment of the present disclosure further provides a manufacturing method of the display panel.

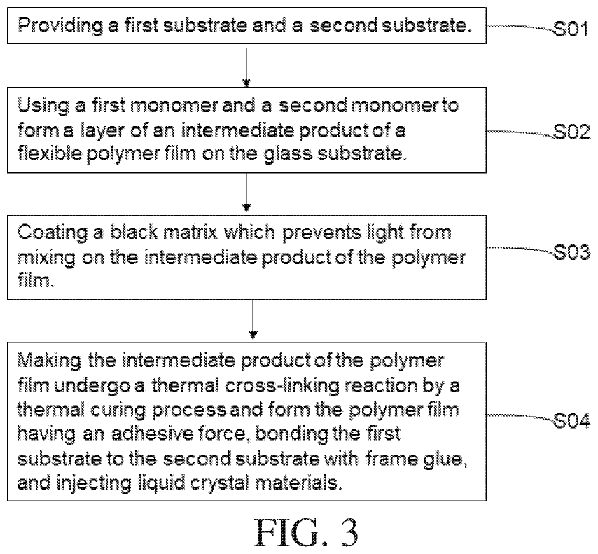

Referring to FIG. 3, FIG. 3 is a flowchart of a manufacturing method of a display panel. The manufacturing method of the display panel comprises:

step S01: providing a first substrate and a second substrate. In an embodiment, the second substrate is a glass substrate.

Step S02: using a first monomer and a second monomer to form a layer of an intermediate product of a flexible polymer film on the glass substrate.

In an embodiment, a thickness of the intermediate product of the polymer film is less than 500 nm, and the first monomer and the second monomer are acrylate derivatives.

Specifically, an induction condition of chemical vapor deposition is ultraviolet light (UV).

Specifically, chemical vapor deposition is a nondestructive transfer, that is, there are no changes in chemical structures during the process.

Specifically, the first monomer is dimethylaminoethyl methacrylate (DMAEMA), the second monomer is 2-chloroethyl acrylate (CEA), and the formed intermediate product of the polymer film has a chain structure. A specific reaction formula is as follows:

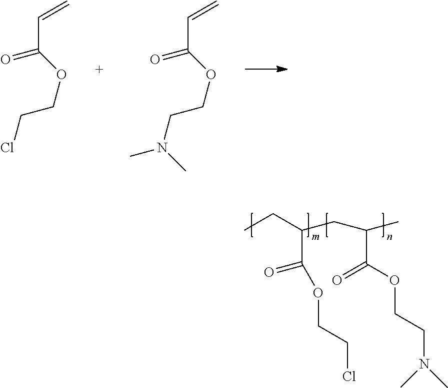

Step S03: coating a black matrix 30 which prevents light from mixing on the intermediate product of the polymer film.

Step S04: making the intermediate product of the polymer film undergo a thermal cross-linking reaction by a thermal curing process and form the polymer film having an adhesive force, bonding the first substrate to the second substrate with frame glue, and injecting liquid crystal materials.

Specifically, a thermal curing reaction temperature ranges from 100° C. to 140° C. In a preferred embodiment, the thermal curing reaction temperature may be 100° C.

Specifically, a thickness of the polymer film is less than 500 nm. In a preferred embodiment, the thickness of the polymer film is 50 nm, and a transmittance of the polymer film is the highest under this condition.

In an embodiment of the present disclosure, the transmittance of the manufactured polymer film 20 ranges from 99% to 100%.

In a preferred embodiment, the polymer film having the adhesive force is a network polymer CEA-co-DEAEMA. A specific reaction formula is as follows:

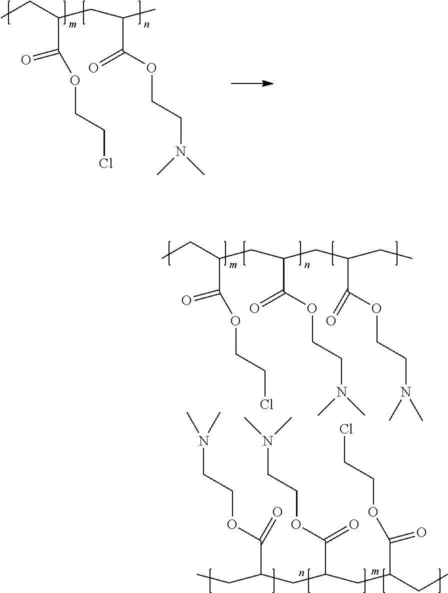

Based on the above embodiments, in another specific embodiment of the present disclosure, it can also solve the technical problem of the present disclosure by changing the order of steps S03 and S04. The changed order of the manufacturing method of the display panel is:

(1) providing a first substrate and a second substrate. In the embodiment, the second substrate is a glass substrate. The second substrate can also be an organic flexible substrate. Specifically, the organic flexible substrate is a polyimide substrate.

(2) Using a first monomer and a second monomer to form a layer of an intermediate product of a flexible polymer film on the glass substrate. Wherein, the first monomer and the second monomer are acrylate derivatives.

(3) Making the intermediate product of the polymer film undergo a thermal cross-linking reaction by a thermal curing process and form the polymer film having an adhesive force.

Specifically, the thickness of the polymer film is 250 nm.

Specifically, the thermal curing reaction temperature may be 140° C. In a preferred embodiment, the thermal curing reaction temperature may be 120° C., and the cross-linking reaction at this temperature is the most complete.

(4) Coating a black matrix which prevents light from mixing on the polymer film, bonding the first substrate to the second substrate with frame glue, and injecting liquid crystal materials.

The embodiments of the present disclosure have following beneficial effects:

The manufacturing method of the display panel provided by the embodiments of the present disclosure uses chemical vapor deposition to manufacture a thin film. The thin film is dense and uniform, and a thickness thereof is controllable. The thickness can be controlled within 500 nm. The method can allow the black matrix 30 to be coated uniformly and can effectively control a thickness of the panel. Solvents are not required in overall manufacturing processes, the processes are controllable, and reaction conditions of the processes are mild, which cannot affect characteristics of other materials in the display panel.

Based on the manufacturing method of the display panel in the above embodiments, an embodiment of the present disclosure further provides a display device. The display device comprises the above display panel or is manufactured by the above manufacturing method of the display panel.

In the above embodiments, the description of each embodiment has its own emphasis. For the parts that are not described in detail in an embodiment, refer to the detailed description of other embodiments above, which will not be repeated here.

The display panel, the manufacturing method thereof, and the display device provided by the embodiments of the present disclosure are described in detail above. Specific examples are used herein to explain the principles and implementation of the present disclosure. The descriptions of the above embodiments are only used to help understand the method of the present disclosure and its core ideas; meanwhile, for those skilled in the art, the range of specific implementation and application may be changed according to the ideas of the present disclosure. In summary, the content of the specification should not be construed as causing limitations to the present disclosure.

What is claimed is:

1. A display panel, comprising a substrate, a black matrix, and a polymer film disposed between the substrate and the black matrix and used to increase an adhesive force between the substrate and the black matrix.

2. The display panel according to claim 1, wherein the polymer film comprises at least one acrylate polymer unit, the acrylate polymer is manufactured according to a first monomer and a second monomer, and the first monomer and the second monomer are acrylate derivatives.

3. The display panel according to claim 2, wherein the first monomer is dimethylaminoethyl methacrylate.

4. The display panel according to claim 2, wherein the second monomer is 2-chloroethyl acrylate.

5. The display panel according to claim 2, wherein the polymer film is manufactured by chemical vapor deposition and a thermal curing process according to the first monomer and the second monomer.

6. A manufacturing method of a display panel, comprising:
using a first monomer and a second monomer to form an intermediate product of a polymer film on a substrate, wherein the first monomer and the second monomer are acrylate derivatives;
coating a black matrix on the intermediate product of the polymer film; and
making the intermediate product of the polymer film undergo a thermal cross-linking reaction to form the polymer film having an adhesive force.

7. The manufacturing method of the display panel according to claim 6, wherein the first monomer is dimethylaminoethyl methacrylate.

8. The manufacturing method of the display panel according to claim 6, wherein the second monomer is 2-chloroethyl acrylate.

9. The manufacturing method of the display panel according to claim 6, wherein the intermediate product of the polymer film is manufactured by chemical vapor deposition according to the first monomer and the second monomer.

10. The manufacturing method of the display panel according to claim 6, wherein the polymer film is manufactured by undergoing the thermal cross-linking reaction in a thermal curing process according to the intermediate product of the polymer film.

11. The manufacturing method of the display panel according to claim 6, wherein a thickness of the polymer film is less than 500 nm.

12. The manufacturing method of the display panel according to claim 6, wherein a thermal curing reaction temperature ranges from 100° C. to 140° C.

13. A display device, comprising a display panel, wherein the display panel comprises a substrate, a black matrix, and a polymer film disposed between the substrate and the black matrix and used to increase an adhesive force between the substrate and the black matrix.

14. The display device according to claim 13, wherein the polymer film comprises at least one acrylate polymer unit, the acrylate polymer is manufactured according to a first monomer and a second monomer, and the first monomer and the second monomer are acrylate derivatives.

15. The display device according to claim 14, wherein a transmittance of the acrylate polymer ranges from 99% to 100%.

16. The display device according to claim 14, wherein the first monomer is dimethylaminoethyl methacrylate.

17. The display device according to claim 14, wherein the second monomer is 2-chloroethyl acrylate.

18. The display device according to claim 13, wherein a thickness of the polymer film is less than 500 nm.

19. The display device according to claim 13, wherein the polymer film is manufactured by undergoing a thermal cross-linking reaction in a thermal curing process according to an intermediate product of the polymer film.

20. The display device according to claim 19, wherein the intermediate product of the polymer film is manufactured by chemical vapor deposition according to a first monomer and a second monomer.
